(19) United States
(12) Patent Application Publication
(10) Pub. No.: US 2015/0240928 A1
(43) Pub. Date: Aug. 27, 2015

(54) BEARING ARRANGEMENT FOR HARMONIC OR STRAIN WAVE GEARING

(71) Applicant: Cone Drive Operations, Inc., Traverse City, MI (US)

(72) Inventor: Kyle M. Jones, Frankfort, MI (US)

(21) Appl. No.: 14/260,715

(22) Filed: Apr. 24, 2014

Related U.S. Application Data
(60) Provisional application No. 61/945,547, filed on Feb. 27, 2014.

(51) Int. Cl. F16H 49/00; F16C 43/06; F16C 19/22

(52) U.S. Cl. CPC F16H 49/001; F16C 19/22; F16C 43/065

(57) ABSTRACT

A bearing arrangement for harmonic or strain wave gearing, wherein the bearing arrangement comprises a mating gear, a wave generator, and gearing between the mating gear and the wave generator. The flexible gearing comprises gear teeth which are engaged with corresponding gear teeth on the mating gear. A plurality of rollers is disposed between the flexible gearing and the wave generator. The rollers may be engaged by a roller cage which is also disposed between the flexible gearing and the wave generator, thereby preventing the rollers from contacting each other and preventing roller-to-roller friction. The rollers ride directly on the exterior surface of the wave generator. As the wave generator moves, the wave generator pushes on the rollers which, in turn, push on the flexible gearing. The flexible gearing, in turn, meshes with the mating gear, thus creating relative motion. The bearing arrangement is such that the rollers roll directly on the flexible gearing and the wave generator, and the rollers experience relative motion between themselves and the wave generator as well as the flexible gearing.

### RELATED APPLICATION (PRIORITY CLAIM)

This application claims the benefit of U.S. Provisional application Ser. No. 61/945,547, filed Feb. 27, 2014, which is hereby incorporated herein by reference in its entirety.

### BACKGROUND

The present invention generally relates to a bearing arrangement for harmonic or strain wave gearing.

Harmonic or strain wave gearing has been used and used for some time. For example, U.S. Pat. Nos. 2,906,143 and 2,983,162 disclose strain wave gearing. Both of these patents are hereby incorporated herein by reference in their entirety. Generally speaking, strain wave gearing is a motion transmitting mechanism, wherein relative motion occurs between an internal gear and a cooperating external gear. More specifically, strain wave gearing operates by deformation of a flexible gearing member having fewer gear teeth than a mating gear. The deformation combined with the difference in gear teeth creates relative motion between the flexible gearing member and the mating gear.

Conventional bearing arrangements used in harmonic or strain wave gearing are difficult to assemble, and are assembled and manufactured in a non-flexible manufacturing process.

### SUMMARY

An object of an embodiment of the present invention is to provide an improved bearing arrangement for harmonic or strain wave gearing.

Briefly, an embodiment of the present invention provides a bearing arrangement for harmonic or strain wave gearing, wherein the bearing arrangement comprises a mating gear, a wave generator, and gearing between the mating gear and the wave generator. The flexible gearing comprises gear teeth which are engaged with corresponding gear teeth on the mating gear. A plurality of rollers is disposed between the flexible gearing and the wave generator. The rollers may be engaged by a roller cage which is also disposed between the flexible gearing and the wave generator, thereby preventing the rollers from contacting each other and preventing roller-to-roller friction.

In operation, as the wave generator moves, the wave generator pushes on the rollers which, in turn, push on the flexible gearing. The flexible gearing, in turn, meshes with the rigid gear, thus creating relative motion. The bearing arrangement is configured such that, in operation, the rollers roll directly on the wave generator, and are in contact with the flexible gearing. The rollers experience relative motion between themselves, as well as with regard to the wave generator and the flexible gearing. The bearing arrangement provides that the inner race of the rollers is the wave generator, and the outer race is the flexible gearing. In this way, the bearing arrangement can be made any dimension and is not limited by the dimensions of the dimensions of the individual components. Additionally, less assembly effort is required compared to at least some bearing arrangement prior art systems.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is an exploded perspective view of a bearing arrangement which is in accordance with an embodiment of the present invention;

FIG. 2 is a top view of the bearing arrangement shown in FIG. 1;

FIG. 3 is a cross sectional view of the bearing arrangement, taken along line 3-3 of FIG. 2;

FIG. 4 is an enlarged view of a portion of that which is shown in FIG. 3, showing a roller relief portion of flexible gearing component of the bearing arrangement; and

FIGS. 5 and 6 show different stages of assembling the bearing arrangement.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

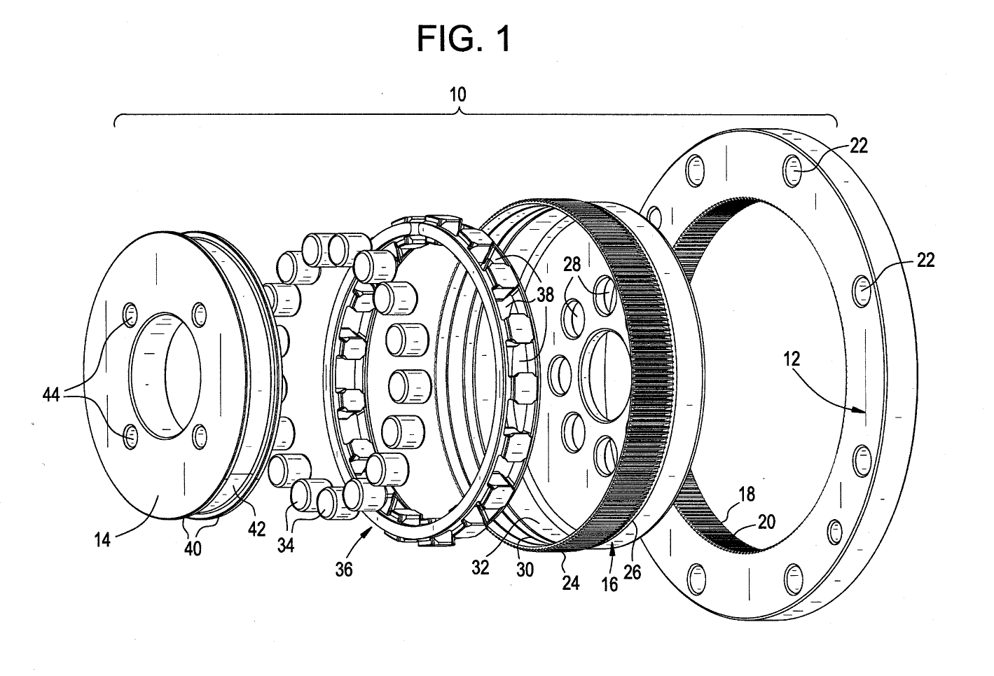

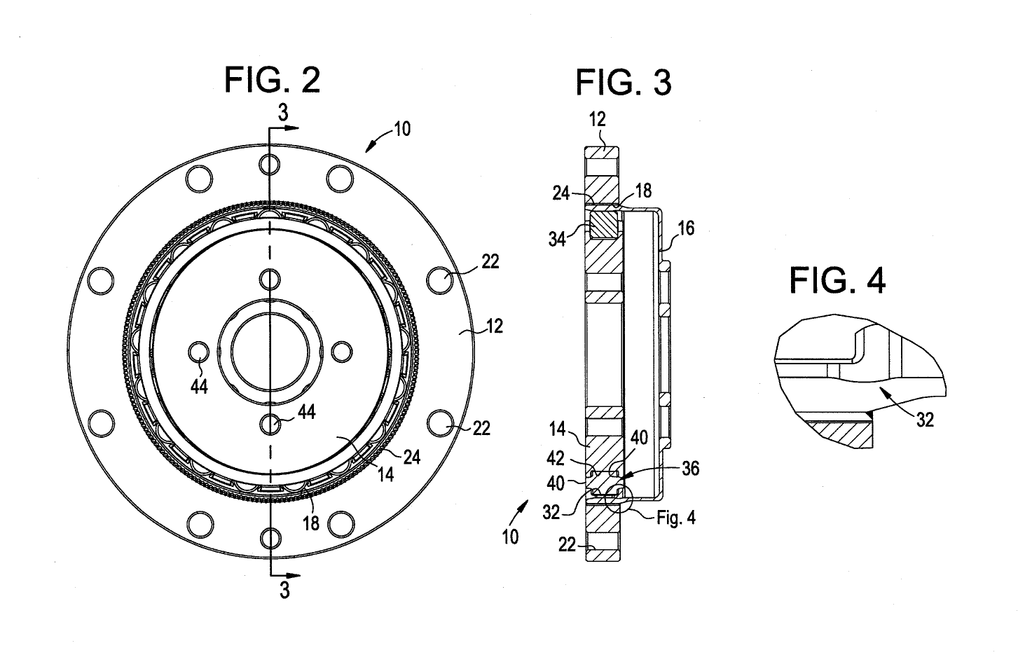

FIG. 1 is an exploded perspective view of a bearing arrangement 10 for harmonic or strain wave gearing, where the bearing arrangement 10 is in accordance with an embodiment of the present invention. FIG. 2 is a top view of the bearing arrangement 10, while FIG. 3 is a cross sectional view of the bearing arrangement 10, taken along line 3-3 of FIG. 2.

As shown in FIGS. 1-3, the bearing arrangement 10 comprises a plurality of components. Specifically, the bearing arrangement 10 comprises a mating gear 12, a wave generator 14, and flexible gearing 16 disposed between the mating gear 12 and the wave generator 14. Preferably, the mating gear 12 is rigid, and has gear teeth 18 along an internal surface 20. As shown, the mating gear 12 may also include mounting throughbores 22, for mounting the mating gear 12 to another component or surface. Preferably, the mating gear 12 is round and the gear teeth 18 are provided along its entire internal surface 20.

The flexible gearing 16 is also round, and is formed of a material that allows the flexible gearing 16 to deform during operation of the bearing arrangement 10. The flexible gearing 16 has gear teeth 24 along its exterior surface 26 (preferably all the way around a perimeter of its exterior surface 26), and these gear teeth 24 mesh with the gear teeth 18 that are provided on the interior surface 20 of the mating gear 12 (preferably, the flexible gearing 16 has fewer gear teeth 24 than does the mating gear 12). As shown, the flexible gearing 16 may also include mounting throughbores 28, for mounting the flexible gearing 16 to another component or surface. An interior surface 30 of the flexible gearing 16 may provide (but does not necessarily have to provide) a recess or roller relief 32 to prevent corners of rollers 34 from digging into the flexible gearing 16 (i.e., the roller relief 32 is configured to minimize contact stress with the rollers 34). This roller relief 32 can be seen in more detail in FIG. 4.

The rollers 34 can take many different forms. For example, each of the rollers 34 may be cylindrical, each having either a square or rectangular profile (meaning each of the rollers 34 may be as high as they are wide (square), or may be taller or shorter than they are wide (rectangular)). Alternatively, each of the rollers 34 may be provided as being spherical (spherical rollers permit the flexible gearing to move relative to the axes of the spherical rollers) or may be provided as being ball bearings. With regard to materials, the rollers 34 may be made of a polymer, metal, ceramic, or any other suitable rigid material which has sufficient strength.

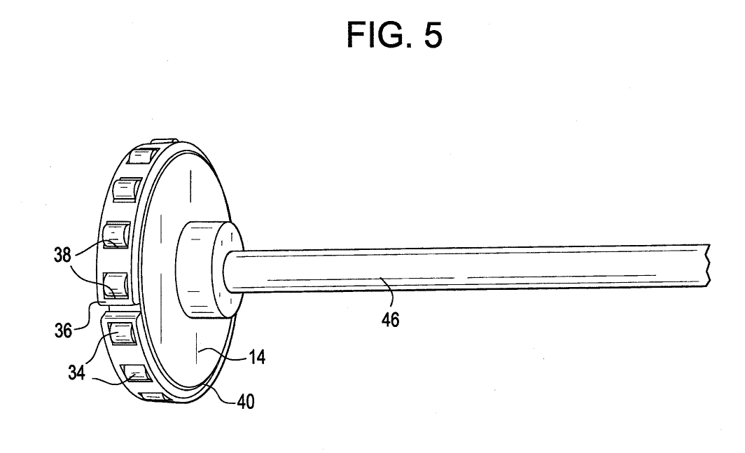

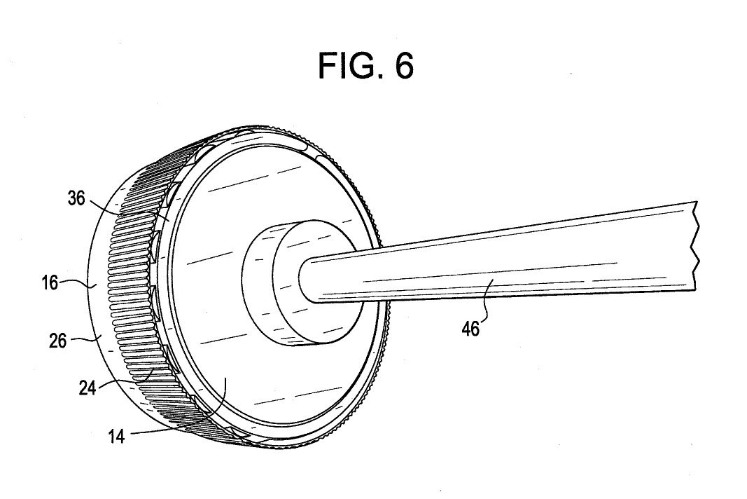

As shown in FIGS. 1 and 3, a roller cage 36 may retain the rollers 34 such that they are prevented from contacting each other (in other words, roller-to-roller contact is prevented). If a roller cage 36 is provided, preferably the roller cage 36 is formed of a material that allows the roller cage 36 to deform along with the wave generator 14, and the material is selected such that the roller cage 36 is able to endure this deformation. Suitable materials may include a polymer or a metal, with a polymer being the preferred choice due to their low weight and ductility. Alternatively, the roller cage 36 can be provided as being rigid and not permitted to deform. As shown in FIG. 1, preferably the roller cage 36 is generally ring shaped and has a plurality of openings 38 provided therein, wherein each opening 38 is configured to receive and retain a roller 34 therein. Preferably, the roller cage 36 is discontinuous (see FIG. 6), meaning it does not go all the away around. This way, the roller cage 36 can be effectively opened and snapped onto an outer surface of the wave generator 14, as shown in FIG. 5, along with the rollers 34.

Preferably, the wave generator 14 is machined of a stiff material such that it is non-round. As shown in FIGS. 1 and 3, containment lips 40 may be provided on an external surface 42 of the wave generator 14, about its entire circumference (see FIG. 1). The containment lips 40 are configured not only to help contain the rollers 34 during assembly of the bearing arrangement 10 (see FIG. 5), but also serve to prevent axial movement of the rollers 34 during operation of the bearing arrangement 10. As shown in FIGS. 1-3, the wave generator 14 may be provided with mounting throughbores 44, for mounting the wave generator 14 to another component or surface. Still further, a coupling (such as an Oldham coupling) may be used to connect an input to the wave generator. FIGS. 5 and 6 show an example where a drive shaft 46 is secured or otherwise mounted on the wave generator 14 such that the drive shaft 46 and the wave generator 14 are coaxial and effectively integral.

To assemble the bearing arrangement 10, as shown in FIG. 5, the rollers 34 are engaged with the roller cage 36 (if provided), and the roller cage 36 is engaged with the external surface 42 of the wave generator (between the containment lips 40, if provided). Then, as shown in FIG. 6, the wave generator 14 along with the rollers 34 and roller cage 36 (if provided) is engaged and installed in the flexible gearing 16, deforming the flexible gearing 16 to a shape dictated by the wave generator 14 and the rollers 34. Once the gear teeth 24 on the flexible gearing 16 are meshed with the gear teeth 18 on the mating gear 12, the overall assembly shown in FIGS. 2 and 3 is provided.

In operation, the rollers 34 ride directly on the exterior surface 42 of the wave generator 14. As the wave generator 14 moves, the wave generator 14 pushes on the rollers 34 which, in turn, push on the flexible gearing 16. The flexible gearing 16, in turn, meshes with the mating gear 12, thus creating relative motion. The bearing arrangement 10 is such that the rollers 34 roll directly on the flexible gearing 16 and the wave generator 12, and the rollers 34 experience relative motion between the wave generator 14 as well as the flexible gearing 16. In the present invention, the wave generator 14 effectively acts as the inner race, and the flexible gearing 16 effectively acts as the outer race, but there is not really a separate inner or outer race.

The present invention permits flexibility in the manufacturing process, as well as requires less assembly effort than prior art system that have bearings physically mounted to the wave generator.

While a specific embodiment of the invention has been shown and described, it is envisioned that those skilled in the art may devise various modifications without departing from the spirit and scope of the present invention.

What is claimed is:

1. A bearing arrangement in a harmonic or strain wave gearing system, said bearing arrangement comprising: a mating gear having gear teeth on an interior surface thereof; a flexible gearing having gear teeth on an exterior surface thereof, wherein the gear teeth on the flexible gearing are meshed with the gear teeth on the mating gear; a wave generator; roller disposed between and in contact with the wave generator and the flexible gearing, wherein the rollers are configured to roll directly on the flexible gearing and the wave generator, and the rollers experience relative motion between themselves and the wave generator as well as the flexible gearing.

2. A bearing arrangement as recited in claim 1, further comprising a roller cage which keeps the rollers out of contact with each other during operation of the bearing arrangement.

3. A bearing arrangement as recited in claim 2, wherein the roller cage has a plurality of openings for receiving and retaining the rollers.

4. A bearing arrangement as recited in claim 2, wherein the roller cage is formed of a polymer or metal.

5. A bearing arrangement as recited in claim 1, wherein each of the rollers is at least cylindrical square, cylindrical rectangular, spherical, or a ball bearing.

6. A bearing arrangement as recited in claim 1, wherein the wave generator comprises containment lips on an exterior surface thereof, said containment lips configured to prevent axial movement of the rollers during operation of the bearing arrangement.

7. A bearing arrangement as recited in claim 1, wherein the wave generator comprises containment lips on an exterior surface thereof, said containment lips configured to contain the rollers during assembly of the bearing arrangement.

8. A bearing arrangement as recited in claim 1, wherein the flexible gearing comprises a recess which is configured to provide roller relief, wherein the recess prevents corners of the rollers from penetrating into the flexible gearing, and is configured to minimize contact stress between the rollers and the flexible gearing.

9. A bearing arrangement as recited in claim 2, wherein the roller cage is configured to engage, and be retained on, an exterior surface of the wave generator along with the rollers, during assembly of the bearing arrangement, before the wave generator is installed in the flexible gearing.

10. A method of assembling a bearing arrangement for use in a harmonic or strain wave gearing system, said method comprising: securing rollers to a roller cage; engaging the roller cage on an external surface of a wave generator; installing the wave generator along with the roller cage and rollers into a flexible gearing; and engaging gear teeth of the flexible gearing with gear teeth on a mating gear.

11. A method of assembling as recited in claim 10, further comprising engaging the rollers in opening provided on the roller cage.

12. A method of assembling as recited in claim 10, further comprising engaging the roller cage to the exterior surface of the wave generator such that the rollers are disposed between two containment lips on the external surface of the wave generator.

13. A method of assembling as recited in claim 10, further comprising installing the rollers in a roller relief which is provided on an interior surface of the flexible gearing.

14. A method of assembling as recited in claim 13, further comprising providing that the roller cage is ring like but is discontinuous to facilitate installation on the exterior surface of the wave generator.

15. A method of assembling as recited in claim 10, further comprising engaging the roller cage to the exterior surface of the wave generator such that the rollers are disposed between two containment lips on the external surface of the wave generator, and installing the rollers in a roller relief which is provided on an interior surface of the flexible gearing.
